(19) United States
(12) Patent Application Publication
(10) Pub. No.: US 2023/0387639 A1
(43) Pub. Date: Nov. 30, 2023

(54) TOOL SET FOR CUTTING, STRIPPING AND/OR CRIMPING AN ELECTRICAL CONDUCTOR

(71) Applicant: Phoenix Contact GmbH & Co. KG, Blomberg (DE)

(72) Inventors: Jonas Korsmeier, Lemgo (DE); Danny Siriboe, Hannover (DE); Jens Frischemeier, Koeterberg- Niese (DE); Sandra Klocke, Vlotho (DE); Kilian Klages, Detmold (DE)

(21) Appl. No.: 18/247,904

(22) PCT Filed: Sep. 17, 2021
(86) PCT No.: PCT/EP2021/075583

§ 371 Date: Apr. 5, 2023

(30) Foreign Application Priority Data
Oct. 9, 2020 (BE) BE2020/5701

(51) Int. Cl. H01R 43/042

(52) U.S. Cl. CPC H01R 43/0421

(57) ABSTRACT

A tool set for cutting, stripping and/or crimping an electrical conductor includes: a hand-operated machine handleable manually by a user; a tool interface; a drive; and at least one tool head for carrying out a function, is connectable to the hand-operated machine via the tool interface, and is drivable in a connected position via the drive. The hand-operated machine has a force determiner for determining a displacement force caused by the drive on the at least one tool head connectable to the hand-operated machine.

### CROSS-REFERENCE TO PRIOR APPLICATIONS

This application is a U.S. National Phase application under 35 U.S.C. § 371 of International Application No. PCT/EP2021/075583, filed on Sep. 17, 2021, and claims benefit to Belgian Patent Application No. BE 2020/5701, filed on Oct. 9, 2020. The International Application was published in German on Apr. 14, 2022 as WO/2022/073743 under PCT Article 21(2).

### FIELD

The disclosure relates to a tool set for cutting, stripping and/or crimping an electrical conductor.

### BACKGROUND

Such a tool set has a hand-operated machine and at least one tool head. The hand-operated machine can be handled manually by a user and has a tool interface and an electromotive drive. The at least one tool head is designed to perform a function, can be connected to the hand-operated machine (1) via the tool interface (11) and can be driven in a connected position via the drive (12).

Typically, the following steps must be performed to prepare a conductor when wiring electrical circuits or when assembling conductors: cutting the conductor to the correct length, stripping and crimping. Crimping here means pressing the conductor with an electrical connector. It is known to use manually, electrically or pneumatically operated hand tools for these steps. In addition, electrically or pneumatically operated table-top devices and systems for fully automatic conductor assembly are also known.

Desirable features include good quality of the electrical connection made with a tool and good ergonomics of the tool. For hand tools, this can mean in particular that little force is required from a user to operate the hand tool and that the hand tool has a low weight. The tool should also be versatile in use. This means, for example, that it should be usable for different cross-sections of conductors and electrical connectors. It should also offer a high level of process reliability. That is, it should, for example, enable high quality cutting, stripping and crimping to be maintained regardless of the user's skills. In addition, the cost of the tool should be low and there should be as little waste as possible of consumables such as electrical conductors and electrical connectors. In addition, low processing time per conductor and ease of operation are desirable.

Hand tools suitable for cutting and stripping are known from the prior art. Hand tools suitable for crimping are also known. Electrically driven hand tools, in which, as in DE 10 2013 107 217 A1, a manual drive is supported by a motor drive if necessary, are used for particularly force- or energy-intensive processes, such as cutting or crimping of conductors with a large cross-section. Hand tools are also known which can be used for the three steps of cutting, stripping and crimping. Hand tools can sometimes be adapted for different applications by means of exchangeable tool heads.

A crimping tool is known from DE 199 32 962 B4 in which the crimp quality is monitored via the crimping force. Errors can be identified by recording the force-path curve and comparing it with predefined values determined by test crimping.

However, for hand tools set up to perform different functions, the displacement force must be estimated by the user for each function or the same displacement force is used for each function, but this may be accompanied by the risk that the functions are performed incorrectly.

### SUMMARY

In an embodiment, the present invention provides a tool set for cutting, stripping and/or crimping an electrical conductor, comprising: a hand-operated machine handleable manually by a user; a tool interface; a drive; and at least one tool head configured to carry out a function, is connectable to the hand-operated machine via the tool interface, and is drivable in a connected position via the drive, wherein the hand-operated machine has a force determiner configured to determine a displacement force caused by the drive on the at least one tool head connectable to the hand-operated machine.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a view of an electrical conductor and a hand-operated machine to which a tool head is connected.

FIG. 2 shows a schematic view of a hand-operated machine connected to a computer device.

FIG. 3 a perspective view of a hand-operated machine.

FIGS. 4A-D show views of tool heads with different functions.

FIG. 5 shows a graphical representation of a displacement path-displacement force curve.

FIG. 6 shows a graphical representation of three displacement path-displacement force curves and two reference curves.

FIG. 7 shows a schematic view of a hand-operated machine.

FIG. 8 shows the schematic view of the hand-operated machine according to FIG. 7, together with a tool head.

### DETAILED DESCRIPTION

In an embodiment, the present invention provides a tool set for cutting, stripping and crimping an electrical conductor with a hand-operated machine and at least one tool head, which offers a high level of process reliability.

Accordingly, the hand-operated machine has a force determiner for determining a displacement force caused by the drive on the at least one tool head connected to the hand-operated machine.

The fact that the force determiner determines the displacement force caused by the drive on a tool head connected to the hand-operated machine can increase process reliability, at least during cutting, stripping and crimping. Of course, other functions are also conceivable, such as twisting or stripping the conductor, which the majority of the tool heads can be designed to perform and which increase process reliability when performed by the hand-operated machine.

In one embodiment, a first tool head of a plurality of tool heads is designed to perform a first function. By contrast, a second tool head of the plurality of tool heads is designed to perform a second function that is different from the first function. Each tool head can be connected to the hand-operated machine via the tool interface and can be driven in a connected position via the drive. In this embodiment, different tool heads, which perform different functions and thus have different functional designs, can thus be detachably connected to the hand-operated machine via the tool interface. One tool head at a time can be connected here to the tool interface in order to perform a function assigned to the tool head. The tool head can be replaced by another tool head in order to operate the hand-operated machine with a different tool head and thus perform a different function.

Instead of being replaced by a tool head with a different function, a tool head can also be replaced by a tool head of the same type, for example in the event of damage, in order to replace the tool head to repair the tool. In any case, however, the tool head can be exchanged and is detachably connected to the hand-operated machine for this purpose via the tool interface.

In one embodiment, a first tool head is designed to perform a cutting function, a second tool head is designed to perform a stripping function, and a third tool head is designed to perform a crimping function. A further tool head can be designed to perform one or more of the following functions: cutting, stripping, twisting, desheathing and crimping a conductor. For example, the further tool head may be designed to cut and twist a conductor. In particular, the further tool head may be designed for cutting, stripping, twisting, desheathing and crimping a conductor. If necessary, a plurality of such further tool heads may be provided. The tool set can thus be used in a versatile way for several work steps, different electrical connectors and different electrical conductors.

Crimping the conductor may include pressing the conductor to an electrical connector. An electrical connector may include, for example, a ferrule, a twisted contact, a cable lug, a B-crimp, or another electrical contact. In this regard, the electrical conductor may be a core of a cable. In particular, the electrical conductor may have a plurality of strands.

Each tool head of the plurality of tool heads can be connected to the hand-operated machine via the tool interface. Each tool head can therefore be attached to the tool interface. The tool interface can, in particular, have a snap-fit or rotary lock by which the tool head can be fixed to the hand-operated machine.

In one embodiment, the at least one tool head has a driver. The driver can be designed to move the tool head to perform a function. The drive can have a piston for transmitting the displacement force. The driver may be couplable to the piston for transmitting the displacement force. An energy for operating the electromotive drive may be drawn by the hand-operated machine from an energy storage device, such as a rechargeable battery or a primary battery. In one embodiment, the hand-operated machine is powered by rechargeable battery.

The drive can generate the displacement force using energy from the energy storage device and can transmit it to the tool head via a transmission. For example, the drive can have a spindle drive. The spindle drive can convert a rotational drive movement of a motor of the drive into a linear movement. The linear movement can be transmitted via the spindle drive to a piston, for example, which can move back and forth. The tool head, in particular the driver of the tool head, can be coupled to the piston so that the displacement force is transmitted to the tool head via the piston. The compact design of the hand-operated machine can support a low weight of the hand-operated machine.

The drive can be controllable with a control unit. The control unit can, for example, have a printed circuit board that is arranged inside the hand-operated machine. The control unit can be coupled to the force determiner so that the force determiner can transmit the determined displacement force to the control unit, for example for evaluation and/or for recording. The control unit can likewise be coupled to the actuator so that the control unit can control the actuator, for example in response to a demand from the user. For this purpose, the user can, for example, actuate a button that triggers a work process. Within a work process, the piston can move back and forth once. A length of the displacement path and a maximum displacement force exerted can thereby be adapted to the particular application by controlling the motor current. The control unit can be set up to control the motor current. The mechanics therefore do not necessarily have to be designed in the tool heads so that all tool heads of a plurality of tool heads operate with the same maximum force.

In one embodiment, the hand-operated machine has a recognition device for recognizing the connected tool head. The recognition device can be set up to recognize the connected tool head. On the one hand, this can be tool heads of different types or tool heads for performing different functions. The hand-operated machine can therefore recognize which tool head is currently being used.

In one embodiment, the recognition device is set up to recognize the connected tool head via a mechanical, magnetic, electrical and/or optical signal. A mechanical signal can be generated, for example, via a mechanical coding of the tool heads, for example via pins, the presence of which can be queried via keys or sensors on the hand-operated machine. An electrical signal can be generated, for example, by an inductive or capacitive sensor or a reed contact. A magnetic signal can be generated, for example, via a magnet arranged on the tool head, the magnetic field strength of which can be measurable with a Hall sensor arranged on the hand-operated machine. An optical signal can be generated, for example, via a light barrier which the tool head interrupts in a predetermined manner. Optical recognition can likewise be made possible by optically reading information about the tool head. For example, the tool head can be recognized via the recognition device on the basis of its shape or on the basis of a barcode or binary code arranged on the tool head. In principle, no additional electronics in the tool head are required for the recognition of the tool head.

The recognition device may, in one embodiment, also be designed, for example, as an RFID reader to read an RFID identifier (so-called tag) of the at least one tool head.

In one embodiment, additional electronics are arranged on the tool head to allow the recognition of the tool head by the recognition device. For example, the tool head can be recognized wirelessly via RFID or NFC. Likewise, the tool head can be recognized via a direct electrical connection or in a wired fashion. In this case, an electrical signal can be transmitted via physical structures between the tool head and the hand-operated machine. For example, the tool head can be recognized via an electrical contact, such as a wire contact.

The control unit can be coupled to the recognition device. Information about the recognized tool head can be transmitted from the recognition device to the control unit. The control unit can be set up to predict a displacement force for performing a function with the recognized tool head already on the basis of the recognized tool head. In particular, the control unit can provide reference values or a reference curve for the displacement force for performing a function with the recognized tool head.

In one embodiment, the control unit specifies parameters such as the displacement force. The control unit can specify the displacement force, for example, by specifying the motor current with which the electromotive drive is driven. The control unit can also specify a speed of the drive. The speed of the drive can be determinable via a rotary encoder. The rotary encoder can determine in particular a speed of the piston.

In the case of an electromotive drive with a stepper motor, the speed can be determined by counting the steps. The control unit can also specify a torque of the drive. The torque of the drive can be used in particular to specify the displacement force. Furthermore, the control unit can alternatively or additionally specify a displacement path along which the tool head can be displaced when performing the function in question. The displacement path can specify a series of displacement positions along which the tool head can be displaced when performing the function in question. In particular, the control unit may specify the displacement force, the speed of the drive, the torque of the drive, and/or the displacement path along which the tool head is displaceable when performing the function in question, depending on the connected tool head. For example, the control unit can preset a different displacement path for the first tool head for performing the first function than for the second tool head for performing the second function. The hand-operated machine can thus be set up to suitably regulate parameters such as motor speed, motor torque, the displacement force to be introduced into the tool head and/or the displacement path, depending on the connected tool head.

In one embodiment, the hand-operated machine has a path determiner for determining a displacement position on the displacement path. The displacement position may be an instantaneous position of the tool head in which the tool head is located when performing the function in question. For example, the displacement position can be an opening angle of a jaw of the tool head into which the conductor can be inserted.

With the path determiner and the force determiner, the hand-operated machine can be set up to determine the displacement force and the displacement position during the execution of a function for processing, for example for cutting, an electrical conductor. In addition, the hand-operated machine can be set up to record the displacement force and the displacement path. For recording the displacement path and the displacement force, the control unit can have a memory device in which the displacement force and the displacement path and, in particular, pairs of values of the displacement position and the displacement force can be stored.

In one embodiment, the control unit is set up to compare pairs of values of the displacement position and displacement force with reference values and/or a displacement path-displacement force curve with at least one reference curve in order to monitor the correct execution of the function in question. Comparing the pairs of values with reference values and/or the displacement path-displacement force curve with at least one reference curve can include calculating a difference in each case from the reference values and/or the at least one reference curve. Monitoring the correct execution of the function in question can include evaluating the magnitude of a difference in each case from the reference values and/or the at least one reference curve.

When monitoring the correct execution of the function in question, various errors can be recognized for each function. When cutting the electrical conductor, errors in the execution of the function, such as damaged or worn cutting edges, can be recognized on the basis of incorrect cutting forces. Incorrect cutting forces can cause deviations of the displacement force from reference values and/or the at least one reference curve. During stripping, an abrupt increase in the displacement force can occur when blades of the tool head, for example stripping blades, hit strands of the conductor. As a result, damage to the strands can be recognized and, as applicable, prevented by monitoring the displacement force over the displacement path.

At least two cases are conceivable in the case of crimping.

In a first case, the displacement force may not increase fast enough after a first contact of the tool head with an electrical connector to be pressed with the conductor or during the deformation of the electrical connector compared to a displacement force-displacement path curve typical for the connected tool head, especially a reference curve. It may then be possible as a fault that a conductor with too small a cross-section for the connected tool head is inserted in the connector. Likewise, the conductor may be missing strands, for example, or some of the strands of a core might not be inserted in the connector.

In a second case, the displacement force can increase very quickly after a first contact of the tool head with an electrical connector to be pressed with the conductor or during the deformation of the electrical connector compared to the displacement force/displacement path curve typical for the connected tool head, in particular a reference curve, so that the maximum force is already reached after a displacement path that is too short. It can then be considered a fault that an incorrect or unsuitable connector was used. For example, a material that is too hard may have been used for a ferrule. Likewise, an incorrect conductor may have been inserted into the connector. For example, the conductor may have a cross-section that is too large for the connector.

The hand-operated machine can be set up to display errors resulting from a deviation of the pairs of values and/or the displacement force/displacement path curve to the user of the hand-operated machine. In one embodiment, the hand-operated machine has a quality indicator that is set up to display a message if the pairs of values deviate from the reference values and/or the displacement path-displacement force curve deviates from the at least one reference curve by more than a predetermined difference. The indication can consist, for example, of an LED of the quality indicator lighting up. The quality indicator may likewise comprise a display on which the deviation is indicated. The quality indicator can also alert the user to the deviation by means of an acoustic signal or a vibration.

In one embodiment, the control unit is coupled to the recognition device to provide the reference values and/or the at least one reference curve depending on the connected tool head. The control unit can provide reference values and/or at least one reference curve for each tool head. Thus, depending on the connected tool head, the control unit can provide in each case the suitable reference values and/or envelopes resulting from at least two reference curves for the monitoring of the execution of a function with the connected tool head.

In one embodiment, the hand-operated machine and/or the at least one tool head has a memory device in which the reference values and/or the at least one reference curve for the particular tool head are stored. The reference values and/or the at least one reference curve may be stored in the memory device of the control unit associated with an identification of the tool head, which the control unit may receive transmitted from the recognition device. The at least one tool head may have a further memory device in which an identification of the tool head may be stored. In particular, the identification of the tool head may comprise identification data, such as an identification number. The further memory device can likewise additionally store the reference values and/or the at least one reference curve for the particular tool head. As a result, the tool heads can be used independently of the hand-operated machine in which the reference values and/or the at least one reference curve for the particular tool head is stored. For example, the tool heads can be used on another hand-operated machine that provides monitoring of the correct execution of the function in question.

The reference values and/or the at least one reference curve can define an allowed range on a plane spanned by possible values of the displacement force and the displacement position. The allowed range is selected by defining the reference values and/or the at least one reference curve in such a way that compliance with a required quality is ensured if the measured displacement force and the measured displacement position lie within the allowed range during the processing of the conductor.

The reference values and/or the at least one reference curve can, for example, be specified at the factory. In one embodiment, the control unit is set up to generate further reference values from the pairs of values of the displacement position and displacement force, or to generate at least one further reference curve from the displacement path-displacement force curve, and to store them in the memory device in addition to the reference values already stored and/or the at least one reference curve already stored. Thus, in addition to the previously stored reference values and/or the previously stored reference curve, further reference values and/or reference curves can be stored by the user. Thus, measured pairs of values and/or measured displacement path-displacement force curves can be converted into reference values and/or reference curves in order to generate templates for performing functions for the tool head.

The control unit can be set up to specify a displacement path. On the one hand, this can be done as a function of the connected tool head. On the other hand, this can also be done depending on a function selected by a user. For example, a tool head can be designed for cutting a conductor. The same tool head can also be used for stripping a conductor, if the displacement path is shortened, so that only an insulation is cut, but not the conductor completely.

In one embodiment, the control unit is set up to specify a shortened displacement path in such a way that a conductor can only be partially stripped by specifying a displacement path with a tool head connected to the hand-operated machine for performing a stripping function, so that a portion of an insulating sheath of the conductor that is cut off during stripping remains on the conductor. Thus, in this embodiment, the displacement path along a longitudinal axis of the conductor is shortened by the control unit. As a result, the severed portion of the insulating sleeve of the conductor is not removed from the conductor, but is left at one end of the conductor. The severed portion can be used, for example, to twist the conductor or to protect the conductor. In this way, the hand-operated machine can be easily adjusted to a desired application or automatically adjusts itself to the desired application.

In one embodiment, the hand-operated machine includes a data interface that allows a computer device to be coupled to the hand-operated machine for transferring data between the computer device and the hand-operated machine. For example, the data interface may include connections via USB, WiFi, or Bluetooth. In particular, the control unit can exchange data with the computer device via the data interface.

Via the data interface, data such as identification data of tool heads used, recorded pairs of values of the displacement force and the displacement position on a displacement path, reference values, recorded displacement path-displacement force curves and/or reference curves can be transmitted to or from the computer device. Thus, said data can be transmitted from the computer device to the control unit and from the control unit to the computer device. In particular, the control unit can be set up to transmit data stored in the memory device to the computer device. The computer device can be, for example, a computer or a mobile device such as a smartphone or a tablet.

In particular, the control unit can be set up to transmit pairs of values recorded for a connected tool head and/or recorded displacement path-displacement force curves with, as applicable, assigned reference values and/or reference curves via the data interface to the computer device for evaluation with a software or app.

In one embodiment, the further reference values and/or the at least one further reference curve can be transmitted via the data interface for storage in the memory device. The computer device can make further reference values and/or at least one further reference curve accessible to the hand-operated machine via the data interface. The further reference values and/or the at least one further reference curve may, for example, have been recorded, created or calculated with another hand-operated machine and/or at an earlier time. The data received from the computer device can additionally or alternatively be stored in the further memory device of the tool head. Likewise, data from the further memory device of the tool head can be transmitted to the computer device via the data interface.

The data interface can also be used to transmit information on the number of cycles performed with a tool head or the hand-operated machine as a whole. The number of cycles can be used to draw conclusions about possible wear, in order to generate a warning about wear or a maintenance interval if necessary.

In one embodiment, the hand-operated machine and/or the plurality of tool heads each have a memory device in which information on wear of the plurality of tool heads and/or a number of times indicating how often a function was performed with the plurality of tool heads can be stored. The number of times can be used, for example, to avoid overloading the hand-operated machine by performing a function too many times. This can be particularly important for mobile use of the hand-operated machine and increases process reliability.

The control device can be set up to specify parameters such as a displacement path-displacement force curve depending on the wear of the connected tool head. In this way, it can be ensured that a tool head that already requires a higher displacement force due to wear does not generate erroneous indications of a deviation of the pairs of values or the displacement path-displacement force curve from reference values or the at least one reference curve. In addition, a user of the hand-operated machine can be alerted to a need for maintenance of the connected tool head based on wear. For example, the wear may scale with the number of times the particular tool head has performed a function. Therefore, the number of times may be storable in the memory device of the hand-operated machine or the further memory device of the tool head. For example, the number of times may comprise a number of performed (processing) cycles of the tool head or a number of processed conductors. If necessary, more specific information on the wear of the tool head can also be stored.

Wear of the tool head can cause increased friction when performing the function of the tool head. The increased friction may require a higher displacement force. In one embodiment, the control unit controls the drive as a function of the wear and/or the number of times. By controlling depending on wear and/or the number of times, the increased displacement force due to wear can be compensated. The number of times can be determined by counting the number of times a function is performed.

The friction can be determined, for example, by a reference run of the tool head without an inserted conductor. A method for calibrating a hand-operated machine can be used for this purpose.

In one embodiment, the hand-operated machine includes an illumination device provided for illuminating the connected tool head. For example, the illumination device may be an LED that is directed at the connected tool head. This can facilitate processing of a conductor inserted into the tool head in low-light conditions.

In a method for calibrating a hand-operated machine of a tool set, the hand-operated machine can be handled manually by a user. The hand-operated machine has a tool interface and an electromotive drive. A tool head is connected to the hand-operated machine via the tool interface and is driven in a connected position via the drive. In the method, the tool head is displaced along a displacement path, preferably without an electrical conductor being disposed on the tool head, and a displacement force is determined to displace the tool head along the displacement path. The displacement of the tool head along the displacement path without an inserted conductor can include the reference run for calibration of the tool head.

With a previously unused tool head, the displacement force along the displacement path without an inserted conductor can be an initial base value. With increasing wear of the tool head, additional friction can occur which increases the displacement force undesirably. The displacement force can then be above the base value even in the event of displacement without an inserted conductor. With the calibration described, the base value can be increased by the determined increased displacement force. This can ensure that the displacement force required to process the conductor can be determined precisely.

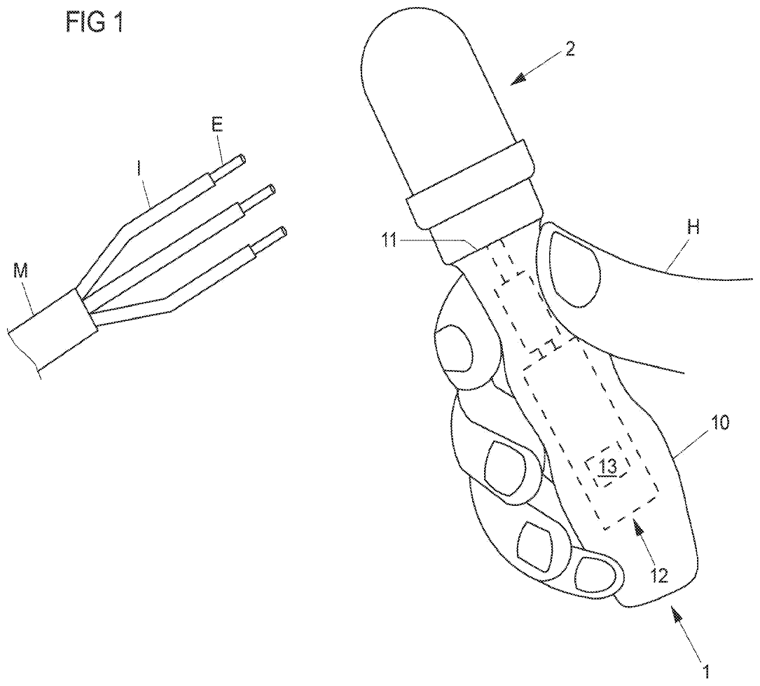

FIG. 1 shows a view of a hand-operated machine 1 with an electromotive drive 12. The hand-operated machine 1 has a tool interface 11, at which a tool head 2 is arranged. The tool head 2 can be driven by the electromotive drive 12. The hand-operated machine 1 is held by a user with one hand H. In the view shown, the user's hand H grips a housing 10 of the hand-operated machine 1. The housing 10 is ergonomically adapted to the hand H for better handling.

The hand-operated machine 1 is part of a tool set for cutting, stripping and crimping an electrical conductor L. In the illustrated exemplary embodiment, the conductor L is a cable with a sheath M. The sheath M sheathes three cores, each of which is sheathed with an insulation I. The tool set can comprise at least one hand-operated machine 1. In one embodiment, the tool set comprises a plurality of hand-operated machines 1 that may differ, for example, by a strength of the electromotive drive 12. Furthermore, the tool set preferably comprises a plurality of different or optionally the same tool heads. With the tool head 2 shown in the illustration, the cores of the conductor L have been stripped so that three electrical contacts E are exposed. The contacts E are not sheathed by the insulation I.

The tool head 2, which is connected to the hand-operated machine 1, is thus designed for stripping. In principle, the tool head 2 can also be designed for cutting the conductor L. Likewise, the tool head 2 can be designed for twisting the conductor L, in particular the contacts E, very particularly strands of the cores. Likewise, the tool head 2 can be designed for desheathing the conductor L, in particular the cable. The tool head 2 can then be used to remove the sheath M of the cable.

The hand-operated machine 1 has a force determiner 13 for determining a displacement force caused by the drive 12 on the tool head 2 connected to the hand-operated machine 1. Thus, the force determiner 13 can be used to determine the displacement force caused by the drive 12 on the tool head 2. Thus, a force acting on the conductor L in the course of performing the function for which the tool head 2 is designed can be determined. For example, in the illustrated exemplary embodiment, when stripping wires there is a risk of damaging the strands by cutting too deeply when cutting the insulation I. However, since the displacement force is lower when cutting the insulation I than when cutting the strands, the force determiner 13 would register an increase in force when the tool head 2 cuts the strands, so that a user of the tool set can be warned.

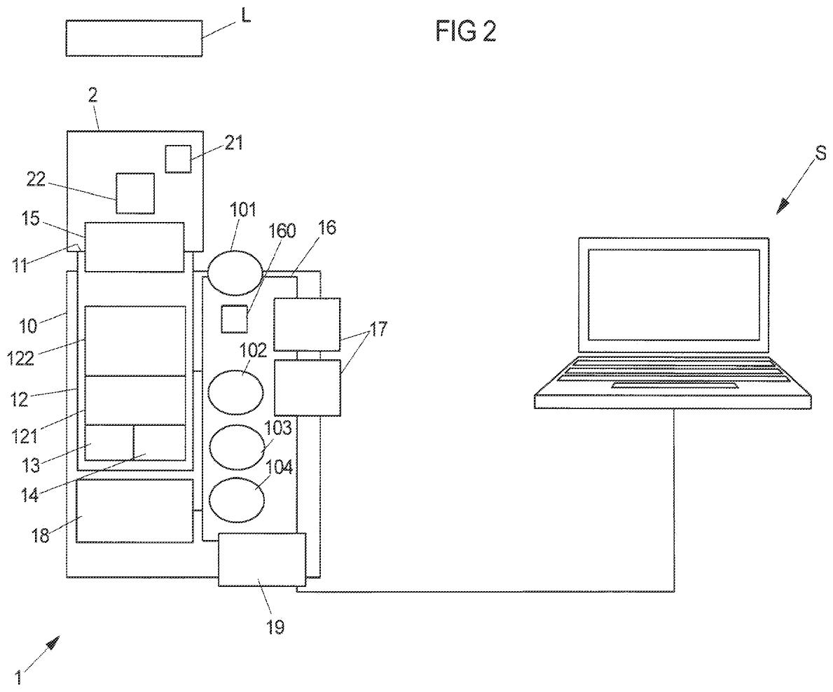

FIG. 2 shows a schematic view of a hand-operated machine 1. The tool head 2 of the hand-operated machine 1 is shown only schematically and is aligned with an electrical conductor L, which is to be processed by the tool head 2. The tool head 2 is connected to the hand-operated machine 1 via a tool interface 11. For example, the tool interface 11 may have a snap-action or twist lock.

Via the tool interface 11, the tool head 2 is connected to an electromotive drive 12, which is arranged on the hand-operated machine 1. The drive 12 comprises a motor 121 that drives the tool head 2 via a transmission 122. The motor 121 may, for example, be an electric motor. Via the transmission 122, the motor 121 can, for example, drive a spindle that converts a rotational movement of the motor 121 into a linear movement with which the tool head 2 can be displaced. Thus, the tool head 2 can be driven by a stroke generated by the motor 121.

The tool head 2 has a driver 22 that interacts with the drive 12 of the hand-operated machine 1 to displace the tool head 2. For example, the drive 12 can have a piston 124 with which the driver 22 can be coupled to transmit the displacement force. For example, the piston 124 can be moved back and forth with the spindle drive.

The hand-operated machine 1 further comprises a recognition device 15 for recognizing the tool head 2. The recognition device 15 is arranged at the tool interface 11, so that a mechanical recognition of the tool head 2 is made possible. For example, the tool head 2 may interact mechanically with the hand-operated machine 1 so that the hand-operated machine 1 recognizes the tool head 2. In one embodiment, the tool head 2 is recognized by a mechanical encoding. In another embodiment, the recognition device 15 is set up to recognize the connected tool head 2 via an electrical signal. For example, the recognition can be performed via a direct electrical connection, such as a plug-in connection. Similarly, the recognition device 15 can be set up to recognize the tool head 2 optically, for example by the recognition device 15 reading a barcode on the connected tool head 2.

In principle, the tool head 2 can exchange data with the hand-operated machine 1 either wirelessly or in a wired fashion. The data may comprise identification data for identifying the tool head 2, so that the recognition device 15 can already recognize the tool head 2 on the basis of the identification data. Additionally or alternatively, via the data exchange, for example, a number of times that a function of the tool head 2 has been performed can also be read and/or stored in the tool head 2.

The hand-operated machine 1 comprises a memory device 160 in which, for example, identification data of the tool head 2 can be stored. Additionally or alternatively, a number of executed functions of the tool head 2 with the identification data can be stored in the memory device 160. The tool head 2 comprises a further memory device 21, in which an identification of the tool head 2 and optionally a number of performed functions of the tool head 2 can be stored. For example, a number of performed cutting operations or stripping operations for a tool head 2 can be stored in the memory devices 21, 160.

When data such as the number of performed functions are stored in the memory device 160 of the hand-operated machine 1, they can be transmitted to the further memory device 21 of the tool head 2. This makes it possible, when the tool head 2 is used on a further hand-operated machine 1, to tell the further hand-operated machine 1 how often a function of the tool head 2 has been performed. This can result, for example, in wear of the tool head 2 or other use-specific parameters for the tool head 2.

An energy storage device 18 is also provided on the hand-operated machine 1 to provide an energy source for the drive 12. The drive 12 and the energy storage device 18 are arranged in a housing 10. The housing 10 can be shaped like a handle.

For controlling the drive 12, the hand-operated machine 1 comprises a control unit 16. The control unit 16 can be used to control the drive 12. The control unit 16 can be set up to regulate a speed of the drive 12, in particular a motor speed, and a torque that the drive 12 exerts on the connected tool head 2, in particular a motor torque. Two actuating devices 17 are provided on the hand-operated machine 1 and are operable by a user of the hand-operated machine 1. In the present case, the actuating devices 17 are in the form of push-buttons or keys. By actuating one of the actuating devices 17, a user can signal to the control unit 16 that the drive 12 is to be started or stopped. By simply actuating with the actuating device 17, a user can be allowed to work ergonomically. This is because high actuation forces can be avoided.

In addition, the control unit 16 is connected to the energy storage device 18. Here, the control unit 16 reads a charging state of the energy storage device 18. An energy indicator 104 is provided on the hand-operated machine 1 and can indicate a state of charge of the energy storage device 18 to a user of the hand-operated machine 1. For example, the energy indicator 104 can indicate to the user a low state of charge of the energy storage device 18 when the energy storage device 18 needs to be replaced.

Furthermore, the control unit 16 is coupled to the recognition device 15. In the present case, the recognition device 15 transmits an identification of the tool head 2 to the control unit 16. The control unit 16 compares the transmitted identification with a list of stored identifications of tool heads, which are stored in the memory device 160, so that stored parameters of the tool head 2 can be retrieved in conjunction with the identification of the tool head 2. For example, the control unit 16 can specify the speed of the drive 12, in particular a motor speed, and/or a torque of the drive 12, in particular a motor torque, depending on the connected tool head 2.

Depending on the tool head 2, the control unit 16 can further specify a displacement force that the tool head 2 exerts on the electrical conductor L during the processing of the electrical conductor L. The displacement force can be regulated, for example, by the current supplied to the drive 12 via the energy storage device 18. In particular, the displacement force can be regulated via a motor current.

The hand-operated machine 1 further comprises a path determiner 14, which is used to determine a displacement position of the tool head 2. The displacement position lies on a displacement path along which the tool head 2 is displaceable when performing the function in question. When cutting, for example, the displacement path may be a path that blades 20a of the tool head 2 must travel to cut through the conductor L.

The control unit 16 is designed to specify a displacement path along which the tool head 2 can be displaced to perform the function in question, for example to allow stripping of a core without damaging strands of the core. This can be of particular importance if cores of different diameters are to be stripped using one tool head. For cores with a larger diameter, the displacement path is less than for cores with a smaller diameter. Accordingly, different tool heads can be designed to process conductors L having different diameters. The control unit 16 is set up to specify the displacement path depending on a diameter of the electrical conductor L and/or depending on the tool head 2 used. Of course, the control unit 16 can also be set up to specify the displacement position depending on the connected tool head 2.

By combining the information about a displacement force determined by the force determiner 13 and a displacement position of the tool head 2, the control unit 16 can perform an evaluation to monitor the correct operation of the tool head 2. For example, if a conductor L is to be processed with a tool head 2 that is not suitable for processing this conductor L, the displacement force and displacement position may deviate from reference values for this conductor L in conjunction with the connected tool head 2. Therefore, the control unit 16 is set up to compare pairs of values of displacement position and displacement force with reference values. This allows it to monitor the correct execution of the function in question.

The reference values or also a reference curve R can be transmitted to the hand-operated machine 1 by a computer device S. For communication with the computer device S, the hand-operated machine 1 has a data interface 19 via which the computer device S is coupled to the hand-operated machine 1. The data interface 19 comprises a USB-C interface. The hand-operated machine 1 is set up to receive reference values, in particular for a connected and identified tool head, from the computer device S and to store them in the memory device 160. The reference values or a reference curve R can likewise be obtained by processing a conductor L with the tool head 2 specified by the identification data. In this case, the reference curve R may comprise an aggregation of reference values. For example, a scenario is conceivable in which a skilled worker processes a conductor L, stores the reference values or the reference curve R in the hand-operated machine 1, and an unskilled worker can refer to the reference values or the reference curve R of the supervisor during the further processing of identical conductors L in order to monitor their own work. Reference values and/or reference curves R generated with the hand-operated machine 1 can be transmitted to the computer device S via the data interface 19.

A reference curve R can also be generated by recording a displacement path-displacement force curve K during the processing of a conductor L and evaluating the quality of the processing of the conductor L afterwards. If the quality of the processing of the conductor L has been evaluated as good, a reference curve R can be generated from the recorded displacement path-displacement force curve K. An envelope curve or an envelope band can be generated from at least two reference curves R, within which curve or band the displacement path-displacement force curve K should be arranged when a function is subsequently performed. On the one hand, this can make it possible to use the reference values or the reference curve R to monitor the execution of the function. On the other hand, it may also be possible to recognize the performed function or features of the electrical conductor L, such as a cross-section of the conductor L, during execution of the function on the basis of the curve of the displacement force over the displacement path.

A quality indicator 103 for the quality of the processing of the conductor L is provided on the hand-operated machine 1. The quality indicator 103 can signal to a user when the pairs of values deviate from the reference values, when the pairs of values deviate from the reference values beyond a predefined difference. For example, the quality indicator 103 may signal a deviation to a user via an LED light illuminating red.

In addition, a status indicator 102 for the status of the machine is provided on the hand-operated machine 1 and can indicate to the user, for example, that the hand-operated machine 1 is ready for operation.

An illumination device 101 is further provided on the hand-operated machine 1 to illuminate the tool head 2. The illumination device 101 is arranged on the housing 10 of the hand-operated machine 1 on the side of the tool head 2, so that a processing region in which the conductor L can be arranged on the tool head 2 is illuminated.

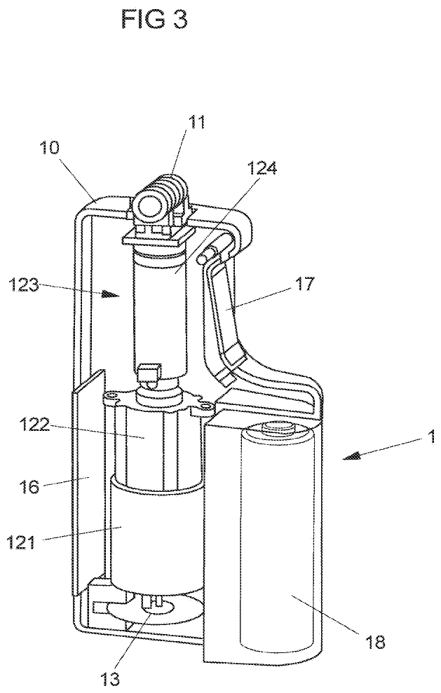

FIG. 3 shows an exemplary illustration of a hand-operated machine 1 in a partially cut-away view. The hand-operated machine 1 has a drive 12 comprising a motor 121, a transmission 122 and a spindle 123. The spindle 123 is coupled to a piston 124 (in threaded engagement with the spindle 123 in the manner of a spindle nut), to which the tool head 2 can be coupled via a tool interface 11. Through the spindle 123, a rotation generated by the motor 121 is convertible into a linear motion. An extent of the linear movement, a stroke, determines the displacement path of a tool head 2 to be coupled.

An applied force for generating the linear movement of the piston 124, a displacement force, can be determined by a force determiner 13 provided on the hand-operated machine 1. The force determiner 13 is coupled to the motor 121, for example, so that the displacement force can be determined via the motor current. The force determiner 13 can likewise comprise a force sensor, for example a strain gauge, DMS. It is also conceivable and possible that the force determiner 13 comprises a spring assembly that absorbs the displacement force. The displacement force can then be determined by measuring the deflection of the spring assembly.

Furthermore, an energy storage device 18 is arranged on the hand-operated machine 1. The energy storage device 18 is arranged parallel to the drive 12. This allows a space-saving arrangement of the energy storage device 18 and the drive 12. Furthermore, this arrangement of the energy storage device 18 parallel to the drive 12 can easily allow a handle-shaped form of the hand-operated machine 1. A portion of the hand-operated machine 1 on which the energy storage device 18 is arranged may be intended to be arranged on a portion of a ring finger of a hand of a user of the hand-operated machine 1. In the intended use, the tool head 2 protrudes from a region of the hand-operated machine 1 adjacent to a thumb region of the user's hand.

An actuating device 17 is further provided on the hand-operated machine 1. In the intended use, the actuating device 17 can be operated by an index finger of the user. For this purpose, the actuating device 17 is arranged between the region in which the energy storage device 18 is arranged and the tool head 2.

The hand-operated machine 1 further comprises a control unit 16, which is coupled to the drive 12 and the actuating device 17, so that an actuation of the actuating device 17 can trigger the drive 12. Furthermore, the control unit 16 is coupled to the force determiner 13 so that the values of the displacement force determined by the force determiner 13 are detectable by the control unit 16.

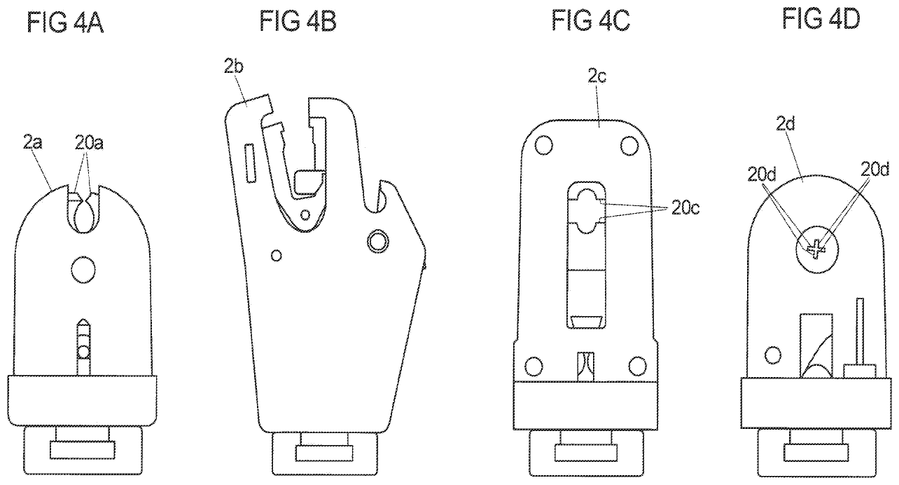

FIG. 4A to FIG. 4D show views of different tool heads, each designed to perform different functions.

A first tool head 2a, shown in FIG. 4A, is designed to perform a cutting function. For cutting, the first tool head 2a comprises two opposed blades 20a between which a conductor L to be cut is insertable. The blades 20a are displaceable toward each other along a displacement path so that the conductor L is cut when the blades 20a meet.

A second tool head 2b, shown in FIG. 4B, is designed to perform a stripping function. A third tool head 2c, shown in FIG. 4C, is designed to perform a crimping function.

The third tool head 2c comprises two opposed plates 20c for crimping, between which a conductor L to be crimped can be inserted. The plates 20c are displaceable toward each other along a displacement path so that an electrical connector, for example a ferrule placed on the conductor L, is crimped to the conductor L when the plates 20c are brought toward each other.

A fourth tool head 2d, shown in FIG. 4D, is also designed to perform a crimping function. For crimping, the fourth tool head 2d comprises four mandrels 20d aligned with a common center, between which a conductor L to be crimped can be inserted. The mandrels 20d are displaceable along a displacement path toward the common center, so that a connector, which can be arranged centered on the common center on the conductor L, can be crimped to the conductor L by the mandrels 20d brought toward one another.

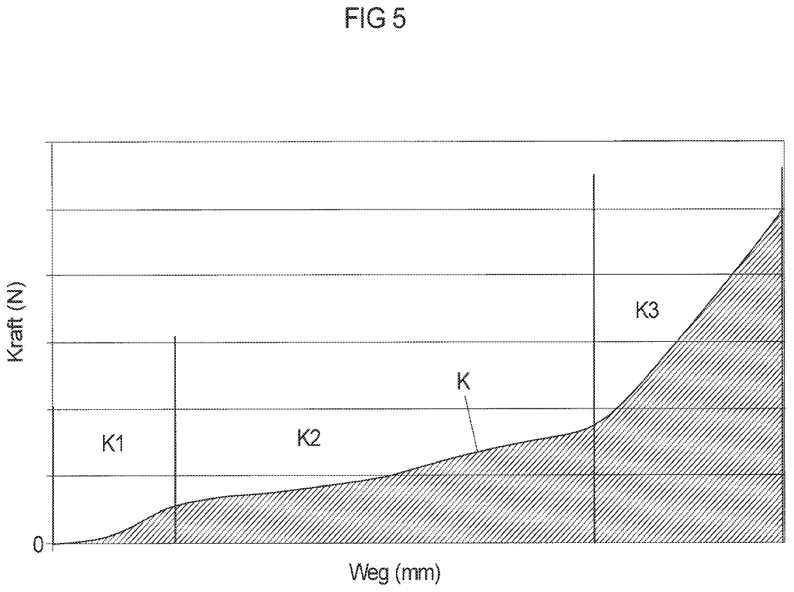

FIG. 5 shows an exemplary displacement path-displacement force curve K, which was measured during the execution of a crimping function of a tool head 2. On the y-axis, a displacement force of the tool head 2 is plotted over a displacement path of the tool head 2 on the x-axis. The displacement path lies between a displacement position of 0 mm and a displacement position of 2.4 mm. In principle, of course, a displacement path of any length is conceivable and possible. The displacement force is between zero and 3000 N. In principle, of course, a displacement force of any magnitude is conceivable and possible.

A connector arranged on a conductor L is initially deformed when the tool head 2 is displaced. The deformation of the connector requires relatively little force. In the example, the force applied to deform the connector is less than 400 N. In a first curve portion K1 of the displacement path-displacement force curve K, the increase in the force curve is therefore relatively small. Here, the displacement path is measured starting from a displacement position at which the tool head 2 is maximally open to a maximally closed displacement position at which the connector is compressed on the conductor L. In a second curve portion K2 of the displacement path-displacement force curve K, the displacement force increases linearly in a flat manner over the displacement path. The connector is pressed into a predetermined shape, for example a rectangular shape, in the second curve portion K2, and the conductor L itself is also deformed. The deformation of the conductor L may comprise, for example, bringing together and laying together strands of the conductor L. In the example, the displacement force applied in the second curve portion K2 is less than 1000 N. In a third curve portion K3, the conductor L itself is pressed. Pressing the conductor L itself may comprise, for example, deforming the strands of the conductor L. The displacement force increases more in the third curve portion K3 than in the second curve portion K2. The increase in the third curve portion K3 is also linear. In the example, the displacement force applied in the third curve portion K3 is less than 2500 N.

Parameters such as the length of the displacement path, over which the displacement force increases approximately linearly, and/or the maximum displacement forces to be applied in each curve portion K1, K2, K3 make it possible to monitor the correct use of the hand-operated machine 1.

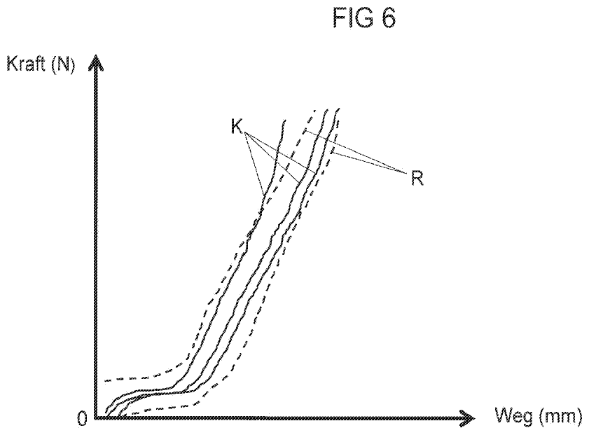

Correct use of the hand-operated machine 1 can be monitored, for example, using reference curves R, as shown in FIG. 6. Shown therein are three exemplary displacement path-displacement force curves K measured during execution of a function of a tool head 2. On the y-axis, a displacement force of the tool head 2 in newtons is plotted over a displacement path of the tool head 2 on the x-axis in millimeters. Also shown are two reference curves R illustrated by dashed lines. The reference curves R form an envelope defining an allowed range of pairs of values of displacement force and displacement path that can occur when processing a given conductor L with the tool head 2 connected to the hand-operated machine 1. Pairs of values outside the allowed range may be indicative of errors in handling or processing, such as a worn tool head 2, an improper conductor L, or an improper tool head 2.

The displacement path-displacement force curves do not initially increase for a short displacement path. The displacement force is almost zero in this range. Then, the displacement force increases very steeply over a short displacement path and is then almost constant for the three displacement path-displacement force curves over a somewhat longer portion of a displacement path. After the portion in which the displacement force is constant, the displacement force increases steeply, but linearly, over the displacement path for the three displacement path-displacement force curves. One of the three displacement path-displacement force curves rises more steeply than the other displacement path-displacement force curves. It intersects one of the reference curves R and thus contains pairs of values that lie outside the permitted range. This may be an indication that an error has occurred during the processing of the conductor L for which the displacement path-displacement force curve lies in part outside the permitted range between the reference curves. Since the displacement force has risen faster than for the other displacement path displacement force curves, an unsuitable connector, for example, may have been used when processing the conductor L. The control unit 16 can determine such a deviation of the pairs of values of the reference values and, in response to the fact that the difference has exceeded a predetermined value, can indicate to the user of the hand-operated machine 1 via the quality indicator 103 that an error may have occurred.

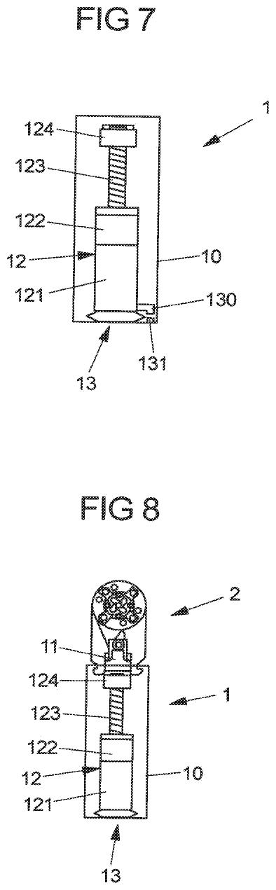

FIGS. 7 and 8 show schematic views of an exemplary embodiment of a hand-operated machine 1, which is designed in the manner of the hand-operated machine 1 shown in FIG. 3 in an exemplary embodiment.

The hand-operated machine 1 has a housing 10 in which a drive 12, consisting of a motor 121 and a transmission 122, is arranged. Via the motor 121 and the transmission 122, a spindle 123 can be set in rotary motion, which is coupled to a piston 124 formed in the manner of a spindle nut, to which a tool interface 11 is connected for (detachable) connection to a tool head 2.

By driving the spindle 123, the piston 124 can be moved linearly along the spindle 123 and the tool head 2 can be actuated thereabove to perform a function associated with the tool head 2, for example for stripping an electrical conductor or for crimping.

A force determiner 13 can, for example, be arranged between the drive train of the drive 12 and the housing 10 in order to receive a force effect between the drive 12 and the housing 10 and to derive, via this, a force effect at the tool interface 11 and thus at the tool head 2. The force determiner 13 can, for example, have a spring assembly so that the drive 12 can be elastically displaced axially along the direction in which the spindle 123 extends relative to the housing 10, wherein a change in position of the drive 12 relative to the housing 10 can be detected, for example optically or mechanically.

For example, as shown schematically in FIG. 7, an active portion 130 can be connected to the drive 12 and interacts with a sensor device 131 on the housing 10. The sensor device 131 can be designed, for example, by an optical sensor device which is designed to determine a distance from the active portion 130 and thus to detect a change in position of the drive 12 relative to the housing 10. The sensor devices 31 may alternatively be designed, for example, by a microswitch that cooperates with the active portion 130 to detect a change in position of the drive 12.

A force measurement in the drive train and thus at the tool head 2 is also possible in other ways, for example by using a strain gauge or a piezo element, by evaluating the motor current of the motor 121 or by using a torque sensor. For example, a torque can be detected at the spindle 23, for example by using a force sensor, for example in the form of a piezo element, which detects a torque load between the drive 12 and the housing 10.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 hand-operated machine
10 housing
101 illumination device
102 status indicator
103 quality indicator
104 energy indicator
11 tool interface
12 drive
121 motor
122 transmission
123 spindle
124 piston
13 force determiner
130 active portion
131 sensor device
14 path determiner
15 recognition device
16 control unit
160 memory device
17 actuating device
18 energy storage device
19 data interface
2, 2a, 2b, 2c, 2d tool head
20a blades
20c plates
20d mandrels
21 further memory device
22 driver
E electrical contact
H hand
I insulation
K displacement path/displacement force curve
K1, K2, K3 curve portion
L electrical conductor
M sheath
R reference curve
S computer device

1. A tool set for cutting, stripping and/or crimping an electrical conductor, comprising:
a hand-operated machine handleable manually by a user;
a tool interface;
a drive; and
at least one tool head configured to carry out a function, is connectable to the hand-operated machine via the tool interface, and is drivable in a connected position via the drive,
characterized in that wherein the hand-operated machine has a force determiner configured to determine a displacement force caused by the drive on the at least one tool head connectable to the hand-operated machine.

2. The tool set of claim 1, further comprising:
a plurality of tool heads a first tool head of which is configured to perform a first function and a second tool head of which is configured to perform a second function different from the first function,
wherein each tool head of the plurality of tool heads is connectable to the hand-operated machine via the tool interface and is driveable in a connected position via the drive.

3. The tool set of claim 1, wherein the at least one tool head is configured to perform one or more of the following functions: cutting, stripping, twisting, desheathing, and crimping a conductor.

4. The tool set of claim 1, wherein the tool interface has a snap-action or twist lock.

5. The tool set of claim 1, wherein the drive comprises a spindle drive.

6. The tool set of claim 1, wherein the at least one tool head has a driver, and
wherein the drive has a piston to which the driver is couplable for transmitting the displacement force.

7. The tool set of claim 1, further comprising:
a control unit with which the drive is controllable.

8. The tool set of claim 7, wherein the control unit is configured to specify the displacement force, a speed of the drive, a torque of the drive, and/or a displacement path along which the at least one tool head is displaceable when performing the function, depending on the at least one tool head.

9. The tool set of claim 1, wherein the hand-operated machine comprises a recognition device configured to recognize a connected tool head.

10. The tool set of claim 9, wherein the recognition device is configured to recognize the connected tool head via a mechanical, magnetic, electrical, and/or optical signal.

11. The tool set of claim 1, wherein the hand-operated machine comprises a path determiner configured to determine a displacement position on a displacement path along which the at least one tool head is displaceable when performing the function.

12. The tool set of claim 11, wherein the hand-operated machine is configured to compare pairs of values of displacement position and displacement force with reference values and/or a displacement path-displacement force curve with at least one reference curve to monitor a correct execution of the function.

13. The tool set of claim 12, wherein the hand-operated machine comprises a quality indicator configured to display an indication of a deviation of the pairs of values from the reference values or of the displacement path-displacement force curve from the at least one reference curve beyond a predefined difference.

14. The tool set of claim 12, wherein the hand-operated machine is configured to specify the reference values and/or the at least one reference curve depending on the connected tool head.

15. The tool set of claim 12, wherein the hand-operated machine and/or the at least one tool head have a memory device in which the reference values and/or the at least one reference curve for the at least one tool head are stored.

16. (canceled)

17. The tool set of claim 12, wherein the hand-operated machine is configured to specify a shortened displacement path such that, with a tool head connected to the hand-operated machine for carrying out a stripping function, a conductor is only partially strippable by specifying a displacement path, so that a portion of an insulating sheath of the conductor that is cut off during stripping remains on the conductor.

18. The tool set of claim 1, wherein the hand-operated machine has a data interface via which a computer device configured to transmit data between the computer device and the hand-operated machine is couplable to the hand-operated machine.

19. (canceled)

20. The tool set of claim 1, wherein the hand-operated machine and/or the at least one tool head have a memory device in which information on wear of the plurality of tool heads and/or a number of times indicating how often a function has been performed with the plurality of tool heads is storable.

21. (canceled)

22. The tool set of claim 1, wherein the hand-operated machine has an illumination device configured to illuminate a connected tool head.

23. A method for calibrating the hand-operated machine of the tool set of claim 1, the hand-operated machine being handleable manually by a user and having a tool interface and an electromotive drive, comprising:
connecting a tool head is connected to the hand-operated machine via the tool interface;
driving the tool head in a connected position via the drive;
displacing the tool head along a displacement path; and
determining a displacement force for displacing the tool head along the displacement path.
